(19) United States
(12) Patent Application Publication
(10) Pub. No.: US 2014/0324899 A1
(43) Pub. Date: Oct. 30, 2014

(54) ENHANCED FOOD INFORMATION MANAGEMENT AND PRESENTATION ON A SELECTIVE DYNAMIC BASIS AND ASSOCIATED SERVICES

(71) Applicant: KITCHOLOGY INC., Germantown, MD (US)

(72) Inventors: Iris Sharon Sherman, Rockville, MD (US); Alain Charles Briancon, Poolesville, MD (US); Steve Goldberg, Delray Beach, FL (US); Barbara Boyce, Newark, DE (US); Dennis Bonilla, Washington, DC (US); Alen Kirkorian, Gaithersburg, MD (US)

(73) Assignee: KITCHOLOGY INC., Germantown, MD (US)

(21) Appl. No.: 14/259,755

(22) Filed: Apr. 23, 2014

Related U.S. Application Data
(60) Provisional application No. 61/815,397, filed on Apr. 24, 2013.
(60) Provisional application No. 61/815,398, filed on Apr. 24, 2013.

(51) Int. Cl. G06F 17/30

(52) U.S. Cl. CPC G06F 17/30595
USPC 707/758

(57) ABSTRACT

A food media processing platform (FMPP) and a computer-implemented method, performed by a processor, are described for processing recipe information for presentation to a consumer. An original recipe stored in a first database may be examined to determine key attributes of the original recipe. The determined key attributes of the original recipe may be contrasted with consumer provided information stored in a second database. At least one modified recipe may be generated based on the contrasting. An algorithm is then performed that compares the key attributes of the modified recipe to a predetermined criteria. The modified recipe may then be presented to the consumer along with supplemental information on a condition that the predetermined criteria has been met.

### CROSS REFERENCE TO RELATED APPLICATIONS

This application claims the benefit of U.S. Provisional Applications No. 61/815,397 and 61/815,398, filed Apr. 24, 2013, which are incorporated herein by reference as if fully set forth. This application is also related to U.S. patent application Ser. No. Not Yet Known filed Apr. 23, 2014 entitled “Presentation Of Food Information On A Personal And Selective Dynamic Basis And Associated Services”, which is hereby incorporated by reference in its entirety.

### BACKGROUND

Food labels and recipes have moved from the realm respectively of food packaging and cook books a few decades ago, to the Internet and the various apparatus used to access them (e.g. computers, tablets, smart phones, and specialized devices). Allrecipes.com (http://www.allrecipes.com), Yummly (http://www.yummly.com/), and Fooducate (http://www.fooducate.com) are but examples of this migration from paper to electronic access. The benefits are universal access without the need of a plethora of physical paper products nearby, and ready access to expanded and new instances of the subject matters. Formats have emerged to represent the different components of a recipe. They include hRecipe, a simple, open, distributed format, suitable for embedding information about recipes for cooking in (X)HTML, Atom, RSS, and arbitrary XML (http://microformats.org/wiki/hrecipe), RecipleML (hap://.formatdata.com/recipeml/spec/recipeml-spec.html).

A food item is a consumable food. A food item may be a naturally occurring food (e.g., apple), or a mixture realized using a recipe (e.g. apple pie). A recipe can be realized at home, a store, or a brand (often referred to a Consumer Packaged Goods Manufacturer, or CPG) manufacturing facility (e.g., NEWCO frozen apple pie).

A ready to make (RTM) food item is a self-contained item that requires a minimum amount of preparation from the consumer, typically warming in a microwave oven. The recipe associated with such an item can be as simple as “remove tray from carton. Put in microwave oven for 3 minutes”.

A home cooked meal (HCM) food item is an item that requires more effort than a RTM.

Raw food eaten directly (e.g., fresh tomatoes) are often considered to be a HCM, even if not cooked, because of the perceived healthier aspect that HCMs have over RTMs.

Leftovers, like say boiled potatoes, can be simply reheated, making them RTM. Other leftovers, like animal fat, can be reused to compose other meals make them HCMs.

Food activities are numerous, grounded in routines and repetitious/cycling in nature. We refer to the ensemble (set) of food activities as a food cycle. We refer to a food event (or food moment) as events in the food cycle. These include, but not limited to, checking inventory, making a shopping list, delegating the shopping, selecting a store, driving to store, login an online store, navigating through the store, shopping for items, redeeming coupons, paying, delivering the food, having the food delivered, planning meals, searching a recipe, modifying a recipe, preparing to cook, cooking, recording cooking issues, setting the table, eating, sharing the experience with others (in person or through, increasingly, social networks).

An ingredient is a substance part of a mixture. The mixtures are food items (aka dishes) realized using recipes. A recipe is the process used to create a mixture. Ingredients, along with recipe (cooking) steps are the cores of recipes, whether the recipe is used to realize a food item at home, store, or brand manufacturing plant. Ingredients are organized, based on type, origin, species, variety and sub-varieties depending on the level of enthusiasm. Consider the simple case of pepper: http://pepper-passion.com/peppercorn-varieties. Ingredients can be introduced by the recipe making (e.g., oil if deep-frying is the cooking method). Ingredients are also listed as quantitative ingredient food labels are essential as consumers become more dependent on processed, consumer packaged foods (part of the broader Consumer Packaged Goods) because, unlike the purchase of perishable items such as fruits, vegetables, meat or staples, the composition of such products cannot readily be determined by visual inspection. Consumer buying a packaged food product that contains fruit cannot, without a label, determine how much fruit is contained in the package.

Two important food label systems used in the US are universal product codes (UPC) and price look-up (PLU) codes. They are typically attached or printed on the ingredient being purchased.

A UPC is used by manufacturers to identify products. A UPC code generally has two parts: numbers, which people can read, and a series of bars that can be scanned and tracked by computers. The numbers generally indicate both the manufacturer and the specific product (or stock-keeping unit (SKU)). The UPC for a 6-pack of strawberry yogurt, a single strawberry yogurt, and single blueberry yogurt from the same manufacturer are different.

PLU codes are four digits identification numbers affixed to produce. They are typically in 3000-4999 range (http://www.plucodes.com/docs/Users_Guide_July_{—}2012_FINAL.pdf), identifying the type of bulk produce, including the variety. The PLU Code for two bananas and one banana are the same. This means that serving information is not readily available based on PLU.

Nutritional information includes elements of the US basic food panel information, called the nutrition facts panel. The label begins with a standard serving measurement; calories are listed second, and then followed by a breakdown of the constituent elements. Normally listed are total fat, sodium, carbohydrates and protein; the other nutrients usually shown may be suppressed if they are zero. Usually all 15 nutrients are shown: calories, calories from fat, fat, saturated fat, trans fat, cholesterol, sodium, carbohydrates, dietary fiber, sugars, protein, vitamin A, vitamin C, calcium, and iron.) If a food has an insignificant amount (less than 1 gram or zero) of a nutrient, then it does not need to be listed on the nutrition facts panel. The design of this food panel is heavily regulated and cannot be arbitrarily modified. As of the writing of this specification however, it is being updated for eventual release as an improved standard.

The nutrition facts panel also lists the serving size and the number of servings per package/container. There is a general lack of understanding of what/how big a serving is, especially in view of restaurant portions and their inconsistency amongst stores.

Food allergens are ingredients protein or non-protein, capable of inducing allergy or specific hypersensitivity. Food allergy is an important public health problem that affects children and adults and may be increasing in prevalence. At the very least, it is increasing in consumer awareness. Because patients frequently confuse non-allergic food reactions, such as food intolerance, with food allergies, there is an unfounded belief among the public that food allergy prevalence is higher than it is. Despite the risk of severe allergic reactions, there is no current treatment for food allergy: the disease can only be managed by allergen avoidance or treatment of symptoms.

According to the Food Allergy and Anaphylaxis Network (http://www.foodallergy.org), as many as 15 million people have food allergies in the US. An estimated 9 million, or 4%, of adults have food allergies. An estimated 6 million, or 8%, of children have food allergies with young children affected most. According to the Journal of the American Medical Association, one third of Americans believe they or their children have a food allergy. Eight foods account for 90% of all food-allergic reactions: milk, eggs, peanuts, tree nuts (e.g., walnuts, almonds, cashews, pistachios, pecans), wheat, soy, fish, and shellfish. Although childhood allergies to milk, egg, wheat and soy generally resolve in childhood, they appear to be resolving more slowly than in previous decades, with many children still allergic beyond age 5 years. Allergies to peanuts, tree nuts, fish, or shellfish are generally lifelong allergies.

Allergens discussed hereunder are a subset of the ingredients of food items (whether listed in recipes or introduced during the cooking or manufacturing process).

Managing allergens is a difficult task that has not been resolved by existing (often static and standardized) solutions. This is true for a multitude of reasons. They include (but not limited to the following):
i. A food item may have different allergens associated with a single consumer (say egg and gluten).
ii. The same food item may have different required allergens levels because its intended consumption might not be with the same group of consumers. Consider a family where multiple members each have their allergy and the handling of meals prepared for all the family or only part of the family.
iii. The terminology of food ingredient is not a precise one. A shopper might call something rice noodle and another simply noodles. This makes the creation of definite and static taxonomy of food items that can be readily understood by consumers impossible.
iv. The terminology of allergens is also not a precise one. Many consumers equate wheat for gluten; even through gluten can also be found in rye and barley.
v. When thinking of taxonomy of food items, allergen might be inherited from class to subclass. A class of food items might have allergens while a subset of that class does not have allergens. For example, generic flour might have gluten vs. garbanzo bean flour might not have gluten.
vi. The “same” food item from one supplier might have allergens another does not have.
vii. Processing impacts the presence of allergens. For instance, in the processing of soy, the lecithin protein within the food may need to be processed in a different manner in order to prevent the allergy-causing elements to be removed from all food products to ensure the food supply is safe and regulated.
viii. While in general one should not provide medical advice unless qualified to do so, a provider of information should be aware however of how consumers look at allergies. There are differences for instance between celiac disease and gluten sensitivity, allergies and food sensitivities.

Helping the consumers deal with nutrition and allergy as general welfare is a key function of governments around the world. These efforts focus on single food items, typically at the procurement oriented stages of the food cycle where the consumer makes purchase decisions.

In the United States, to comply with Food Allergen Labeling and Consumer Protection Act (FALCPA, Food Allergen Labeling and Consumer Protection Act of 2004, 21 USC 301), the major eight allergens must be declared in simple terms, either in the ingredient list or via a separate allergen statement. See http://www.fda.gov/Food/LabelingNutrition/FoodAllergensLabeling for details. However, FALCPA does not regulate the use of advisory/precautionary labeling (e.g., “may contain”, “in a facility that also processes”) is voluntary. The terms do not reflect specific risks and random products tested for allergens have shown a range of results from none to amounts that can cause reactions.

Although there have been significant advances in scientific tools and data resources since the report's 2006 publication, the Food and Drug Administration (the FDA is the agency that administers the FALCPA) current intent is to determine if the currently available data and analysis tools are sufficient to support a quantitative risk assessment and, if so, to use these data and tools to evaluate the public health impact of establishing specific regulatory thresholds for one or more of the major food allergens.

The European Union has for examples 14 allergens on its lists to even include celery, lupines and sulfites. Industry is being pressured to move away from the wording of “may contain” labeling, as it cannot be used for definite decision making by consumers. Moving to a binary (contains/does not contain) is however difficult to manage. This is true because measurement accuracy will not let a manufacturer or third party tester detect certain items beyond a ppm or ppb level. Thus, an extremely small amount might found itself in the food item (a major issue for cross contamination).

The group VITAL (Voluntary Incidental Trace Allergen Labeling) system developed by the Allergen Bureau of Australia and New Zealand and is now referenced by numerous other countries as well, includes a “traffic light” labeling system. If the allergen level falls in the green zone, no precautionary statement is needed, yellow indicates that a “may be present” (may contain) statement is needed; red denotes that allergen labeling is required.

However well intentioned these approaches are, they suffer from a fundamental flaw that different individuals and different families have different needs for nutrition and allergens information and any solution that does not take these individuals and families information into account is less than optimal. Any printed solution is fundamentally flawed from the perspective of being tailored to the needs and circumstances of consumers.

The advent of smartphones with their scanning capabilities (using the camera) and high-speed access to the Internet and thus databases have brought up new ways to display nutrition information. This is one of the primary ways through which food media has been digitized.

The digitization of food media content (recipes, cook books, grocery circulars) and the ready availability of nutrition data from the USDA Nutrient Database for standard reference (http://www.ars.usda.gov) and others allows the computation of key nutritional attributes in a ready manner.

Packages (typical form factor of Ready to Make—RTMs) have a UPC code to allow for scanning. Different SKUs (Stock Keeping Unit) have different SKU. In a typical application, the consumer scans the UPC code and specific information about nutrition is being displayed with more fields. The designs of this digitized food media is set by the applications.

Digital recipe solutions follow the same broad principles as scanning centric applications. The recipe is parsed using natural language processing, items identified, their nutritional attributes extracted, then added across all ingredients of the recipes.

To be made relevant, the food information being presented should be made context-aware. U.S. Patent Application Publication No. 2013/0175337 by Briancon et al. teaches making scanned information context dependent.

Besides providing recommendation about similar like recipes, legacy solutions do not provide tools for the consumer to do scenario planning such as injecting information about impact of specific items on the recipe.

Current digital food media legacy systems are closed systems in that a single entity controls the content and the manner in which information is being displayed. Advertising (directed or through advertising network) is at times inserted as banners throughout the displayed information.

To be more effective, third parties should be involved in the production of the information to be presented to the consumer, making the food information a platform for education and commerce. These third parties could be other consumers (crowd sourcing), support organizations such as associations helping people coping with food allergies or public interest groups, as well as commercial entities such as retailers and brand manufacturers.

Providers of recipes usually need a way to monetize their involvement. Yummly for instance established an advertising platform allowing for user search parameters and preferences to trigger the display of advertisements that are likely beneficial to the user (http://finance.yahoo.com/news/yummly-announces-revolutionary-advertising-platform-130500950.html). It allows for the search of recipes based on expressed preferences, and the identification of brands that could be used to make up the components of the recipes selected. While this approach provides benefits to suppliers and consumers alike, it has limitations with respect to context-awareness, linkage to specific SKUs, linkage to position in the food cycle, purchasing options, and compliance with goals. All of which will be addressed by the present invention.

U.S. Pat. No. 7,228,493 by Kosak et al. teaches the examination of the content of a web page, and based upon it inserting additional components into the page such as syndicated content including news feeds, weather information, stock information, road maps, pictures, video, audio and/or text. This insertion is done in a manner that is substantially in the style of the source file. This allows the blending of commercial content with the original web page. It does not seek to replace the look and feel of the web page, something that can benefit the consumer greatly. It has limitations with respect to context-awareness, linkage to specific SKUs, linkage to position in the food cycle, purchasing options, and compliance with user goals. All of which will be addressed by the present invention.

US Patent Application Publication No. 2014/0089321 by Engel et al. teaches recommending recipes based on consumer criteria (like and dislike) and processing of specific nutritional variable. It is similar to U.S. Pat. No. 8,364,545 by Arsenault, which teaches dealing with food and wine pairing in that both use nutrition scores to present information and make recommendations. These two inventions do not take consumer specific context into account, change the look and feel of the communication, and provide purchasing options, all of which will be addressed by the current invention.

### SUMMARY

A food media processing platform (FMPP) and a computer-implemented method, performed by a processor, are described for processing recipe information for presentation to a consumer. An original recipe stored in a first database may be examined to determine key attributes of the original recipe. The determined key attributes of the original recipe may be contrasted with consumer provided information stored in a second database. At least one modified recipe may be generated based on the contrasting. An algorithm is then performed that compares the key attributes of the modified recipe to a predetermined criteria. The modified recipe may then be presented to the consumer along with supplemental information on a condition that the predetermined criteria has been met.

Recipes are examined to ascertain their key attributes, and based on these key attributes, additional information elements are selected that will be of benefit to the consumer based on his circumstances. The additional information elements may be specific instances of ingredients that the consumer may want to consider using because they are favorably priced in general, a coupon is available for their purchase, or a particular store is offering it at a discount. When considering multiple ingredients, the information could be such that a significant subset of the ingredients is available from a particular distribution source. A key attribute of the presented methods is that they deal with the modification of existing recipes based on a calculated like or dislike individuals have for the resultant recipe. A key circumstance is the consumer activity position in the food cycle. The apparatus supporting these methods is an advanced food media processing platform (FMPP).

A FMPP can be implemented in many ways. The hardware, for instance but not restricted to, may be a personal device specifically designed for individuals to utilize for a given purpose, or a general use device where the FMPP function is selectively operated by means of a special program being on the hardware platform (Personal computer running Windows or MacOS operating systems, portable phone running Android or iOS operating system), or a general access program such as an Internet browser connecting to a web site hosted on a remote computer. In general, they all use at least one computer processing device, memory for immediate processing of information, and memory for long term storage of information.

The FMPP in order to provide the complex and diverse information and processing necessary to the implementation of the present invention, will usually have means to communicate with other computer processing and information storage platforms. Some of these may be other FMPP instances, while many will be ignorant of the existence of FMPPs.

FMPPs have integrated or remotely accessible human interfaces for both the user of the platform's capabilities, and for various personal necessary to its maintenance.

Described herein are methods and apparatus for the displaying of nutritional information for ingredients, prepared foods, prepared meals that ascertain consumer and item key attributes, consumer circumstances and based on these key attributes select information elements that will be of benefit to the consumer. A key attribute of the presented methods is that they deal with the presentation of nutrition metrics based on a like or dislike individuals have for specific items. A key circumstance is the consumer activity position in the food cycle. The apparatus supporting these methods is an advanced food media processing platform (FMPP).

### BRIEF DESCRIPTION OF THE DRAWINGS

The following detailed description of the preferred embodiments of the present invention will be better understood when read in conjunction with the appended drawings. For the purpose of illustrating the invention, they are shown in the drawings embodiments, which are presently preferred. It is understood, however, that the invention is not limited to the precise arrangements and instrumentalities shown. In the drawings:

FIG. 1 shows a food cycle with constituent parts for procurement and consumption, and implication for the display of food related information by a food media processing platform (FMPP);

FIG. 2 is an example of price look-up (PLU) codes interpreted by embodiment of the invention;

FIG. 3 shows the different users and components of an FMPP supporting nutrition management and presentation services per the precepts of this invention;

FIG. 4 shows the structure of a modification/replacement engine component of a food media processing engine; and

FIG. 5 is a flow diagram of a procedure for processing recipe information for presentation to a consumer.

### DETAILED DESCRIPTION OF EXEMPLARY EMBODIMENTS

Certain terminology is used in the following description for convenience only and is not limiting.

As used herein, “connected” means that elements within the system are connected physically or through a remote connection such that they are functionally connected. This connection can be temporary or permanent. As a non-limiting example, a remote connection may be through a localized Radio Frequency link. Another non-limiting.

The words “grocery store”, “supermarket”, “store”, “commerce”, “commerce-site”, “ecommerce” are used interchangeably unless stated otherwise.

Stores can be brick and mortar stores or virtual/digital on the Web/Internet.

Coupons can be physical (paper, circular) or electronic (on PC, phone).

As used herein, “scanning” means extracting information from a object from another device. Non-limited examples include using an optical camera, Infrared, RF, RFID, microphone.

The words “coupon”, “electronic coupon” and “e-coupon” are used interchangeably.

The words “extractor”, “extraction device” and “extracting device” are used interchangeably.

All numbers expressing quantities of ingredients, goods, properties, and other parameters used in the specification and claims may be modified in all instances by the term “about.” Unless indicated to the contrary, the numerical parameters set forth in the following specification and attached claims are approximations that may vary depending upon the desired properties to be obtained. At the very least, and not as an attempt to limit the application of the doctrine of equivalents to the scope of the claims, each numerical parameter should at least be construed in light of the number of reported significant digits and by applying ordinary rounding techniques.

All numerical ranges herein include all numerical values and ranges of all numerical values within the recited numerical ranges. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The words “a” and “one,” as used in the claims and in the corresponding portions of the specification, are defined as including one or more of the referenced item unless specifically stated otherwise. This terminology includes the words above specifically mentioned, derivatives thereof, and words of similar import. The phrase “at least one” followed by a list of two or more items, such as “A, B, or C,” means any individual one of A, B or C as well as any combination thereof.

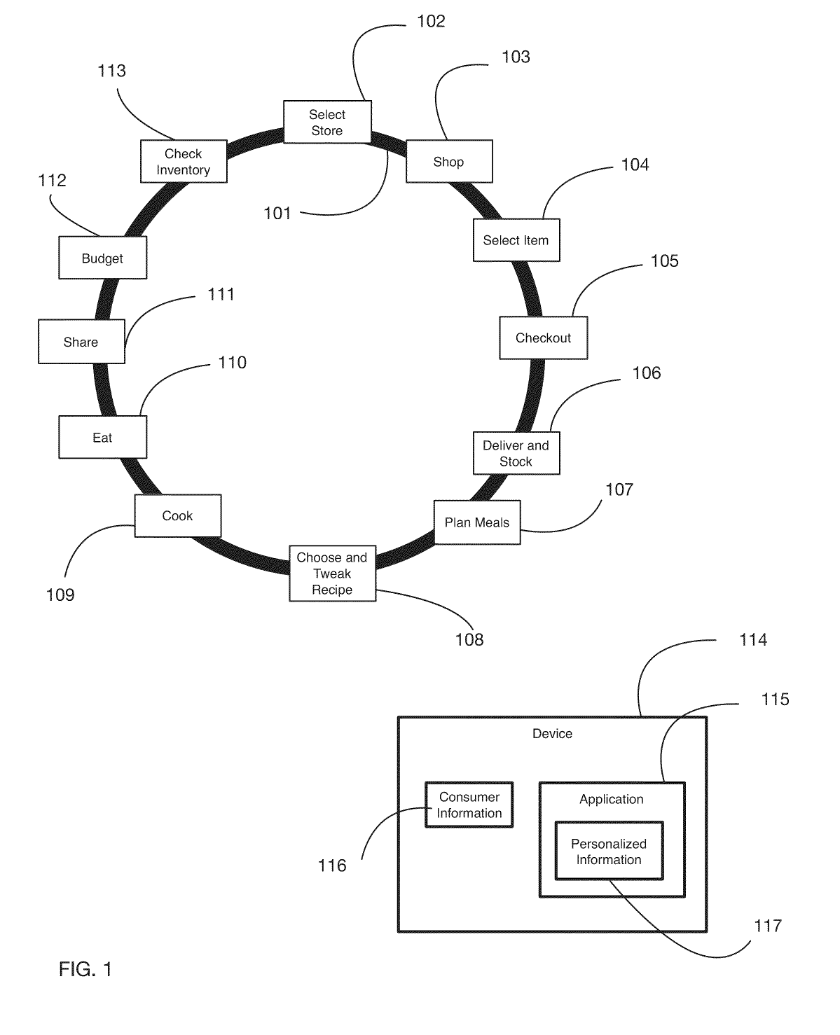

FIG. 1 illustrates a conceptual food cycle (101) used by the consumer and a food media processing platform (FMPP). It includes, but not limited to and doesn't assume a specific sequencing, selecting a store (102) which may be online, shopping (103) that is the examination of one or more items or services (e.g., delivery option), selecting an item (104), an essential moment for marketing, checking out (105), delivery and stocking (106), which involves physical interaction with food, plan meals (107), choose and tweaking recipe (108), cooking (109), eat (110), alone or with others, sharing the experience (111), budget (112), and checking inventory (113) are exemplary instances of the steps during which this invention may be employed.

FIG. 1 shows the general form of a device (114) the consumer utilizes in their exchange of information with the FMPP enabled by this invention. Typical devices, but not limited, to are cellular telephones, personal digital assistants, general use computers in all their instances (e.g., desktops, laptops, netbooks, work stations, electronic pads, wearable), and specialized computers such as those made to enhance the shopping experience. The specialized versions are usually simpler to use since they are targeted to a specific use, and therefore not burdened by extraneously hardware or software needed for other purposes. The device is running an application (115). Based on the consumer information (116) and the estimation of the location within the food cycle, the same conditions will trigger different information to be presented to the consumer (117). This information can be presented in whole or in part using text, audio, video, image, sound, vibration or a combination thereof.

In an embodiment, the information presented to the consumer for a recipe, a food item or any other food related item or processing step is different at different points on the food cycle. The position in the food cycle can be explicitly set by the user or implied from processing one or more external stimuli.

In one embodiment, machine learning is used to estimate at which point in the food cycle a function is performed. Having this estimation is important for instance where scanning is used as part of the process. For instance, scanning can be used at a store (food cycle locations 103, 104, 105), scanning can be used at home (food cycle locations 106, 107, 112, 113). Knowing through geo-location if the consumer is at home or away allows the ready determination of which cluster of food cycle this interaction is most likely to be in. Rapid sequential scanning of food of the same type, say soups is likely the selection of soups to purchase (103) rather than finding a recipe that leverages said soup (107, 108). In the former case, nutrition information (or a coupon offer) is more appropriate to be presented. In the latter, recipe information is more appropriate. The consumer of course always has the option to override the conclusion presented by machine learning. Such an override may also be taken into account the next time, a similar situation is determine to be in effect for a particular consumer, or temporally taken into account if the consumer appears to be performing an exception to normal activity. The latter being the case when shopping is occurring, but the consumer wanted to examine a recipe to determine some information.

In another embodiment, the consumer information is static. In another embodiment, the consumer information is dynamic.

In an embodiment, a mobile application running on a smart phone is used to present information on a selective basis based on its estimate of the position on the food cycle.

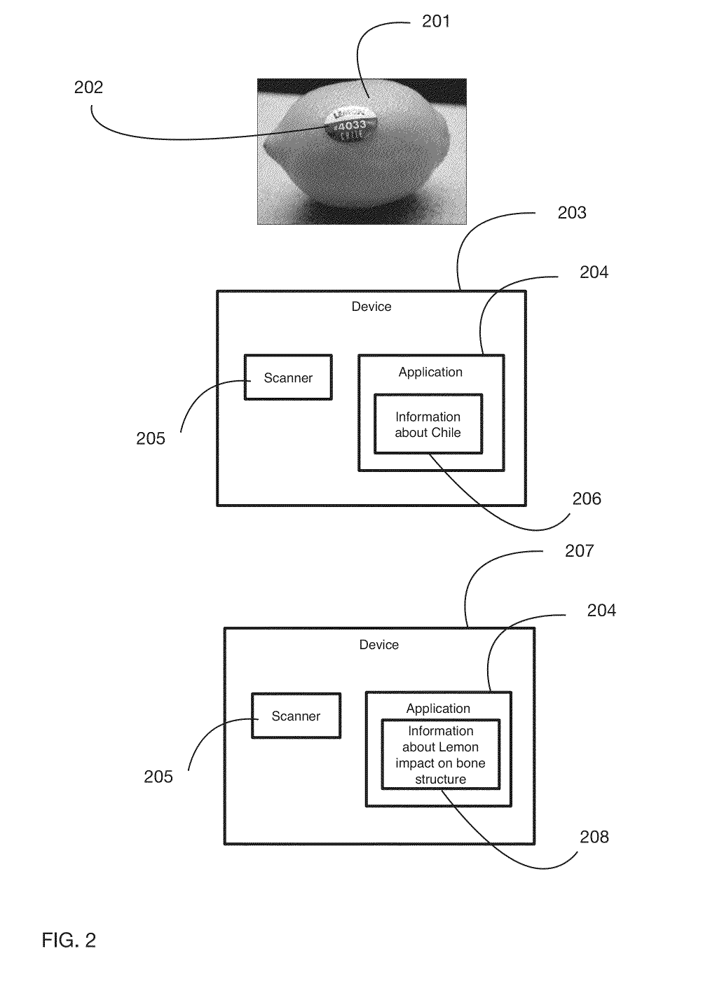

While involved in each of the steps of procurement and consumption of food, the user is presented with many forms of information when interfacing with the Food Media Processing Platform. FIG. 2 shows an embodiment of the invention dealing with rich contextual information triggered by a price look-up (PLU) code. The PLU code may not be directly useful to the consumer, but when inputted to a computing resource implementing this invention, provides the means to access various databases and obtain from them information about the tagged food.

As shown in FIG. 2, a lemon (201) may have a PLU label (202) affixed to it. Two devices (203) and (207) running an embedded application (204) may extract the PLU information through scanning (205) using optical character recognition or directly entered by the user (components not shown) by a keypad or verbalization. The device (203) may be programmed to display country of origin information when scanning a PLU code and present the country of origin (206) to a consumer. The device (207) may be programmed to display health information when scanning a PLU code and present information about the impact of a lemon on bone structure (208) to the consumer.

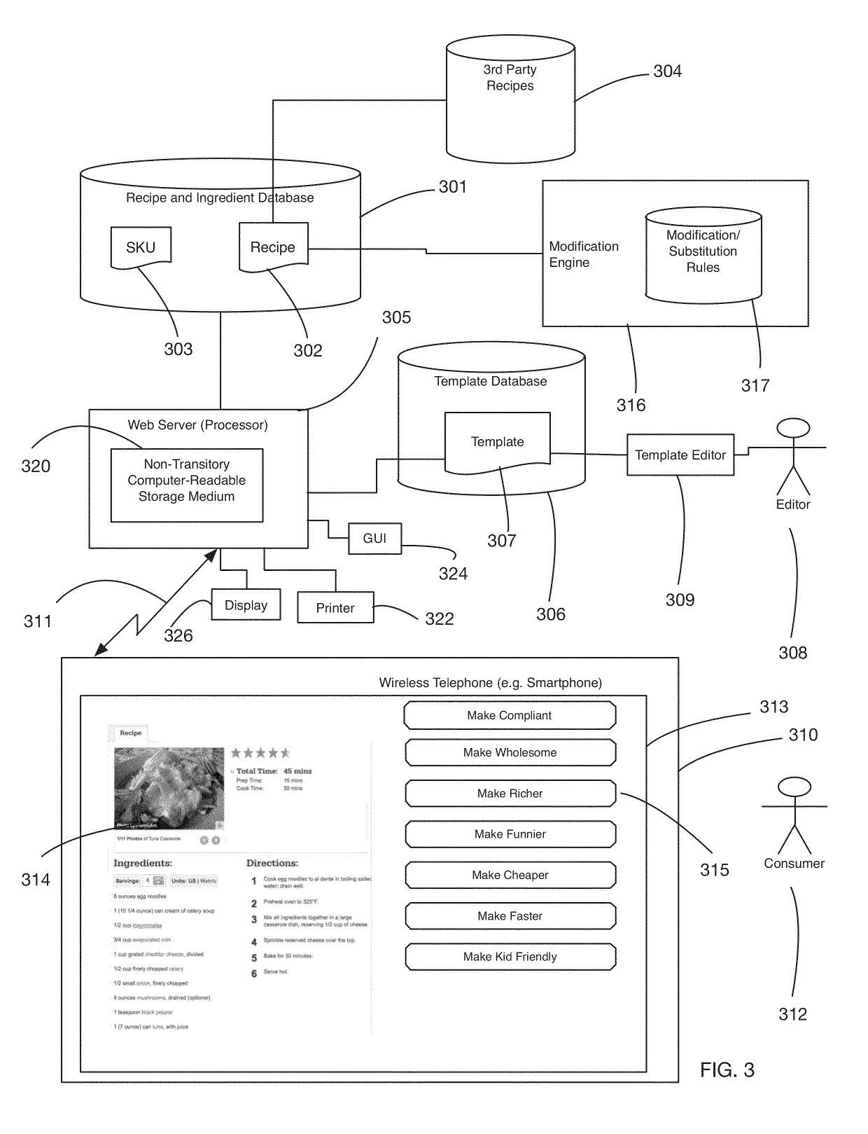

FIG. 3 shows the different users and components of a food media processing platform (FMPP) supporting nutrition management and presentation services per the precepts of this invention.

The food media process engine used to modify recipes is showed in FIG. 3. A database (301) of recipes (302) and stock-keeping unit (SKU) (303) includes ingredients, steps, pictures, pricing, availability and other information relevant to the procurement, nutrition and use of food. This database can interface with one or more 3^{rd} party database (304). A web server (305) interfaces with the database and a template database (306) that contains a set of templates (307) used to create different look and feel to present recipes and their changes. Editors (308) can update this template and insert static and dynamic media using a template editor (309). Using a wireless telephone (i.e., smartphone) (310) connected to the web server (305) via a wireless connection (311), a consumer (312) may search and change recipes using an application (313). Once a recipe (314) has been chosen, the consumer (312) may select one or more goals (315) he or she seeks for transformation. Those goals may be forwarded to a modification engine (316) that determines which modification and substitution rules to perform (317).

As shown in FIG. 3, the web server (305) may be a processor including a non-transitory computer-readable storage medium (320). The processor may perform a computer-implemented method for processing recipe information for presentation to a consumer. The web server (305) may be connected to a printer (322), a graphical user interface (GUI) (324) and a display (326).

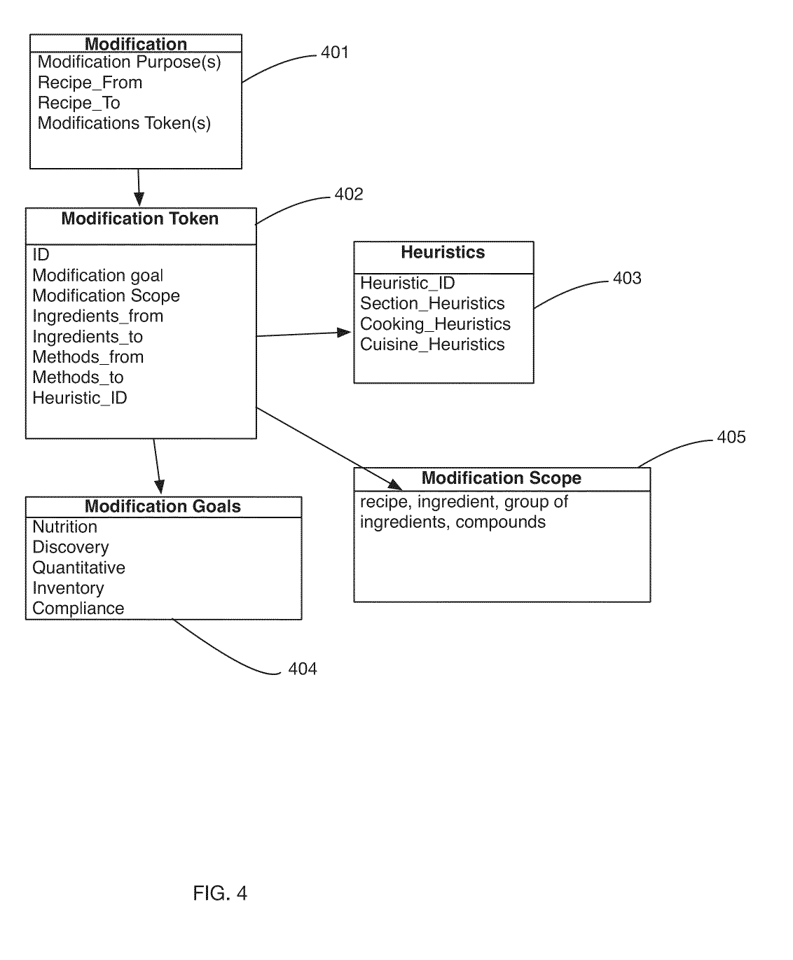

FIG. 4. shows the different elements of the recipe modification engine described above. Modifications (410) are organized according to purpose. They include one or more modifications tokens (402). These tokens have heuristics (403) determining when they can be used. Modification goals (404) can be diverse and of different nature. The modification scope (405) controls how much change is impacted by each token.

To perform a recipe modification, a database maintains a set of ingredient substitution tokens (ISTs) associated with specific transformation goals. These ISTs have associated heuristics restricting or enabling when they should be used. These heuristics can be related to the quantity of ingredients used in a recipe, the location of the ingredient in the ingredient list, the purpose of the ingredient in the recipe, the cooking or preparation method associated with said ingredient, the type of dish the recipe is enabling. The basic algorithm behind the substitution of one or more ingredients is:
a. The querying of valid ISTs for the ingredient(s) to be substituted compatible with the goal of the substitution;
b. The organization of said ISTs into a substitution list (ISTL);
c. The presentation of elements of said ISTL to the consumer as part of a recipe presentation information; and
d. The optional selection of elements from said ISTL by the consumer.

In one embodiment, multiple substitution goals are triggered sequentially.

In another embodiment, ISTs have multiple goals associated with them and multiple substitutions are triggered concurrently.

In another embodiment, ISTs have one or more goals with them and multiple substitutions are triggered concurrently.

In another embodiment, the substitution goals are organized in a triggering hierarchy.

In another embodiment, the ITSs are organized as a flat file with no hierarchy or rank ordering. Provided that they comply with the same goals, all ISTs valid for a specific ingredient (or set of ingredients) are deemed valid and included in the ISTL.

In another embodiment, the ISTs are hierarchical in nature and the selection of one or more ISTs preclude the selection of one or more other ISTs.

In another embodiment, the elements presented in the recipe information are ingredients.

As modifications to recipes progresses, the applicability of auxiliary information changes. Different Consumer Product Goods (CPG) will be of importance, and with it which unbranded and branded information that benefits the consumer. This information will be selectively presented to the user in various forms: listings of CPGs, possible substitutions (partial lists, with links to fuller lists on demand), and advertisements indicating availability locations, coupon options, and so on.

In another embodiment, the elements presented are advice about ingredients.

In another embodiment, the elements presented are purchase information about ingredients such as pricing, availability.

A key attribute of the present invention is that it deals with the modification of existing recipes based on a calculated like or dislike individuals have for the resultant recipe.

The consumer can utilize the recipe modification capabilities of the invention in a number of ways:

In one embodiment, the consumer invokes their and/or other people's profiles with a given recipe. The processing platform determines if the profiles necessitate modification of the recipe in order to conform to the restrictions indicated. The modification capabilities are then used to change the recipe in a minimal fashion to comply with said restrictions. The modified recipe is presented to the consumer, with information regarding the changes to the recipe such as the calculated like and dislike score, availability of ingredients, cost effects, and the like.

In another embodiment the consumer expressly indicates an ingredient of a recipe that they would like to change. The consumer's request is processed under any constraints indicated (e.g., cost, shopping allowed, ingredients must be on-hand, etc.), and modified versions are made available with information regarding the changes to the recipe as previously mentioned.

In another embodiment the consumer may not specify a particular recipe, but indicate the use of a particular list of ingredients (e.g., what is on-hand in their household), recipe classification(s) (e.g., low caloric, 4 course meal, particular meal, reduced sodium, ethnic group) and so on. The processing platform then searches for existing recipes meeting the requirements, and if a significant number of options are not found, modifications on existing recipes that meet the consumer indicated desires are performed within existing constraints.

In another embodiment, the consumer's preferences may be indicated in the form of preferences over multiple recipes, that is a meal plan. Equilibrium of recipes attributes across multiple meals may be the constraint being managed.

The additional information outlined in the previous paragraphs can be presented to the consumer in many forms. In one embodiment the consumer may see a text or image indication of additional information, and there is an indication that a hypertext link is present. Selecting the text or image may reveal a text an information overlay with details about the additional information. In another embodiment selecting the text or image may have the interface verbalize the additional information. In yet another embodiment selecting the text or image may invoke a like to another source of information, where the link may for instance be a hyperlink to a web page or an email composition window with an address to the source of information. For the email or web page instances the user may be prompted for personal information in order to customize the presentation or information to their situation. Alternately some or all of the personal information can be automatically provided, and only additional information solicited as needed to fore fill the consumer's interactions with the information source.

While perusing sources of information via the various means indicated in this invention, the consumer can identify certain information as being of specific interest. For instance additional information about a food or brand may be of interest, and when identified by the user it can be added to their shopping lists. The information may include the store or stores where the item is available, the cost at various stores, coupons or other promotions available, store hours, in stock status, and the like.

Alternately although not expressly identified by the consumer as being of interest, the FMPP may track information or the means to obtain it that may be of use to the consumer. The consumer then has the option of utilizing this information at a latter step in the process. For instance when it comes time to generate shopping lists from their selection of recipes or ingredients, the tracked information can be examined to aid in the filling out of the shopping lists. In one embodiment any missing items identified would just be added to the appropriate list. In another embodiment the consumer would be prompted to identify an appropriate list for needed ingredients, and possible sources would be identified first from the tracked information and secondly from real time information obtained from their preferred vendor lists.

Another key attribute of the present invention is the concept of taxonomy of recipes and their constituents. A consumer may search for related recipes by moving around the taxonomy structure. The Yummly platform uses this approach to a limited extent. The present invention enhances the concept by calculating a relative like value given the attributes of the recipes under consideration and the parameters associated with the consumer. The consumer parameters being ones such as dietary constraints, existing inventory, expressed and calculated likes and dislikes, historical results, and other information which may be specific to membership in a group (e.g., ethnic association) or an individual.

The present invention uniquely extends the concept or recipe selection by enabling modifications to existing recipes, and via the use of like and dislike calculations projecting how well a new recipe will be accepted by consumers. In one embodiment, as the consumers use the system their grading of projected like and dislikes is fed back into the calculations for the like and dislike algorithms, enhancing their accuracy and adjusting individual users preferences as they change over time. In another embodiment machine learning, such as but not limited to cooperative filtering, is used to accelerate this adaptation process.

An integral component of the issuance of a recipe modification may be an invitation or trigger (referred to as an information trigger) to engage in a transaction or other activity related to that recipe modification). Any type of transaction or activity may be proposed or offered, whether commercial or non-commercial in nature. Examples of transactions or other activities that may be proposed or offered include, but are not limited to, matters related to advertising, lead generation, affiliate sale, classifieds, featured list, location-based offers, sponsorships, targeted offers, commerce, retailing, marketplace, crowd sourced marketplace, excess capacity markets, vertically integrated commerce, aggregator, flash sales, group buying, digital goods, sales goods, training, commission, commission per order, auction, reverse auction, opaque inventory, barter for services, pre-payment, subscription, brokering, donations, sampling, membership services, insurance, peer-to-peer service, transaction processing, merchant acquiring, intermediary, acquiring processing, bank transfer, bank depository offering, interchange fee per transaction, fulfillment, licensing, data, user data, user evaluations, business data, user intelligence, search data, real consumer intent data, benchmarking services, market research, push services, link to an app store, coupons, digital-to-physical, subscription, online education, crowd sourcing education, delivery, gift recommendation, coupons, loyalty program, alerts, and coaching.

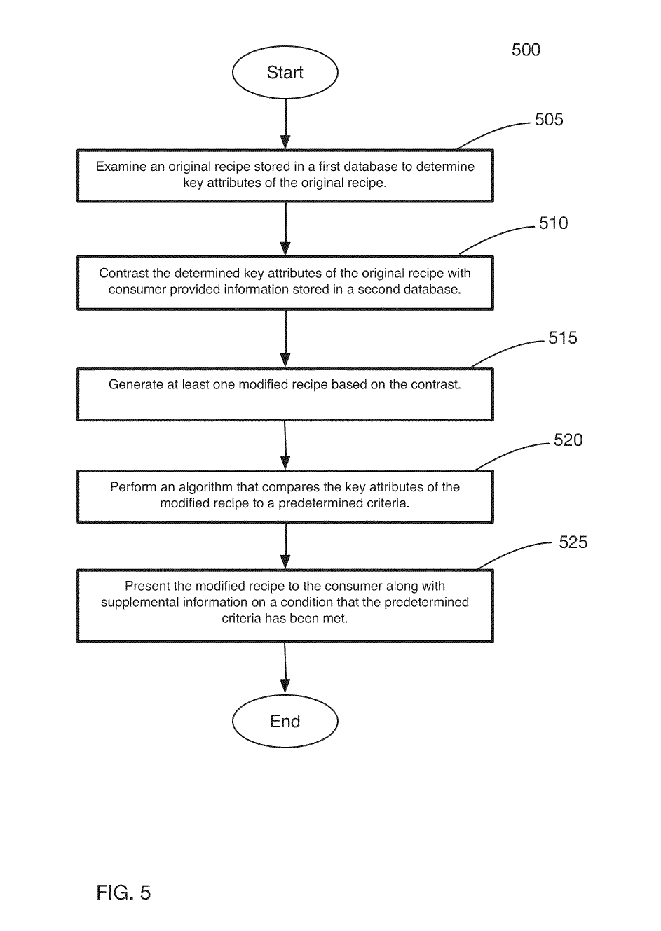

FIG. 5 is a flow diagram of a procedure 500 performed by a processor, such as the web server 305 shown in FIG. 3. In the procedure 500 shown in FIG. 5, a computer-implemented method is performed by a processor for processing recipe information for presentation to a consumer. The processor may examine an original recipe stored in a first database to determine key attributes of the original recipe (505). The processor may contrast the determined key attributes of the original recipe with consumer provided information stored in a second database (510). The processor may generate at least one modified recipe based on the contrast (515). The processor may perform an algorithm that compares the key attributes of the modified recipe to a predetermined criteria (520). The processor may present the modified recipe to the consumer along with supplemental information on a condition that the predetermined criteria has been met (525).

The criteria may indicate at least one of: consumer nutrition restrictions, diet compliance restrictions, food items on hand, shopping list information, position in a food cycle, a food list to be bought prior to need, food item procurement opportunities before need, likes and dislikes, or activities from selected consumers.

The key attributes may be determined based on at least one of: text and images of the presented supplemental information and modified recipe, historical information related to the consumer, historical information related to navigation that brought the consumer to the presented supplemental information and modified recipe, or information available from references the presented supplemental information and modified recipe makes to other sources.

The algorithm may be a like or dislike rating algorithm that is configured to determine potential desirability of modified recipes to a consumer, and recipes to be presented to the consumer are selected based on ratings computed by the like or dislike rating algorithm. This algorithm may be derived, (in a non-limiting manner), from sensory modeling, machine learning, cooperative filtering and/or upload of ancillary data, (e.g., loyalty information).

The contrasting by the processor may determine at least one of: ingredient availability in the dwelling where the recipe is to be prepared, shopping plans, costs to purchase ingredients of the recipe, purchase prices, convenience to obtain, and alternate recipe ingredient options.

The supplemental information presented may be at least one of: selection of stores where at least one necessary ingredient of the recipe can be obtained, brands or stock-keeping units (SKUs) suitable for at least one necessary ingredient of the recipe, or a consumer buying incentive.

The consumer may provide information includes lists indicating which stores the consumer is willing to visit and not willing to visit. The lists may be enabled or disabled for selected items or in their entirety at the discretion of the consumer.

The modified version of the recipe may include at least one brand name of an ingredient of the recipe. The modified version of the recipe may include an alternate ingredient that meets a requirement specified by the consumer provided information in place of an ingredient in the original recipe. The supplemental information may be embedded in the modified recipe.

The supplemental information may be a trigger for at least one of: advertising, lead generation, affiliate sale, classifieds, featured list, location-based offers, sponsorships, targeted offers, commerce, retailing, marketplace, crowd sourced marketplace, excess capacity markets, vertically integrated commerce, aggregator, flash sales, group buying, digital goods, sales goods, training, commission, commission per order, auction, reverse auction, opaque inventory, barter for services, pre-payment, subscription, brokering, donations, sampling, membership services, insurance, peer-to-peer service, transaction processing, merchant acquiring, intermediary, acquiring processing, bank transfer, bank depository offering, fulfillment, licensing, data, user data, user evaluations, business data, user intelligence, search data, real consumer intent data, benchmarking services, market research, push services, link to an app store, coupons, subscription, online education, crowd sourcing education, delivery, gift recommendation, coupons, loyalty program, alerts, coaching, advertising message budgeting information, audio media rendering, or video media rendering.

Referring again to FIG. 3, the non-transitory computer-readable storage medium (320) may contain a set of instructions for processing recipe information for presentation to a consumer. The set of instructions may include: 1) a first instruction for examining an original recipe stored in a first database of the system to determine key attributes of the original recipe; 2) a second instruction for contrasting the determined key attributes of the original recipe with consumer provided information stored in a second database; 3) a third instruction for generating at least one modified recipe based on the contrasting; 4) a fourth instruction for performing an algorithm that compares the key attributes of the modified recipe to a predetermined criteria; and 5) a fifth instruction for presenting the modified recipe to the consumer along with supplemental information on a condition that the predetermined criteria has been met.

The references cited throughout this application, are incorporated for all purposes apparent herein and in the references themselves as if each reference was fully set forth. For the sake of presentation, specific ones of these references are cited at particular locations herein. A citation of a reference at a particular location indicates a manner in which the teachings of the reference are incorporated. However, a citation of a reference at a particular location does not limit the manner in which all of the teachings of the cited reference are incorporated for all purposes.

It is understood, therefore, that this invention is not limited to the particular embodiments disclosed, but is intended to cover all modifications which are within the spirit and scope of the invention as defined by the appended claims; the above description; and/or shown in the attached drawings.

What is claimed is:

1. A computer-implemented method, performed by a processor, for processing recipe information for presentation to a consumer, the method comprising:
the processor examining an original recipe stored in a first database to determine key attributes of the original recipe;
the processor contrasting the determined key attributes of the original recipe with consumer provided information stored in a second database;
the processor generating at least one modified recipe based on the contrasting;
the processor performing an algorithm that compares the key attributes of the modified recipe to a predetermined criteria; and
the processor presenting the modified recipe to the consumer along with supplemental information on a condition that the predetermined criteria has been met.

2. The computer-implemented method of claim 1 wherein the criteria indicates at least one of: consumer nutrition restrictions, diet compliance restrictions, food items on hand, shopping list information, position in a food cycle, a food list to be bought prior to need, food item procurement opportunities before need, likes and dislikes, or activities from selected consumers.

3. The computer-implemented method of claim 1 wherein the key attributes are determined based on at least one of: text and images of the presented supplemental information and modified recipe, historical information related to the consumer, historical information related to navigation that brought the consumer to the presented supplemental information and modified recipe, or information available from references the presented supplemental information and modified recipe makes to other sources.

4. The computer-implemented method of claim 1 wherein the algorithm is a like or dislike rating algorithm that is configured to determine potential desirability of modified recipes to a consumer, and recipes to be presented to the consumer are selected based on ratings computed by the like or dislike rating algorithm.

5. The computer-implemented method of claim 1 wherein the contrasting determines at least one of: ingredient availability in the dwelling where the recipe is to be prepared, shopping plans, costs to purchase ingredients of the recipe, purchase prices, convenience to obtain, and alternate recipe ingredient options.

6. The computer-implemented method of claim 1 wherein the supplemental information presented is at least one of: selection of stores where at least one necessary ingredient of the recipe can be obtained, brands or stock-keeping units (SKUs) suitable for at least one necessary ingredient of the recipe, or a consumer buying incentive.

7. The computer-implemented method of claim 6 wherein the consumer provided information includes lists indicating which stores the consumer is willing to visit and not willing to visit.

8. The computer-implemented method of claim 7 wherein the lists can be enabled or disabled for selected items or in their entirety at the discretion of the consumer.

9. The computer-implemented method of claim 1 wherein the modified version of the recipe includes at least one brand name of an ingredient of the recipe.

10. The computer-implemented method of claim 1 wherein the modified version of the recipe includes an alternate ingredient that meets a requirement specified by the consumer provided information in place of an ingredient in the original recipe.

11. The computer-implemented method of claim 1 wherein the supplemental information is embedded in the modified recipe.

12. The computer-implemented method of claim 1 where the supplemental information is a trigger for at least one of: advertising, lead generation, affiliate sale, classifieds, featured list, location-based offers, sponsorships, targeted offers, commerce, retailing, marketplace, crowd sourced marketplace, excess capacity markets, vertically integrated commerce, aggregator, flash sales, group buying, digital goods, sales goods, training, commission, commission per order, auction, reverse auction, opaque inventory, barter for services, pre-payment, subscription, brokering, donations, sampling, membership services, insurance, peer-to-peer service, transaction processing, merchant acquiring, intermediary, acquiring processing, bank transfer, bank depository offering, fulfillment, licensing, data, user data, user evaluations, business data, user intelligence, search data, real consumer intent data, benchmarking services, market research, push services, link to an app store, coupons, subscription, online education, crowd sourcing education, delivery, gift recommendation, coupons, loyalty program, alerts, coaching, advertising message budgeting information, audio media rendering, or video media rendering.

13. A food media processing platform (FMPP) comprising:
a first database;
a second database; and
a processor configured to examine an original recipe stored in the first database to determine key attributes of the original recipe, contrast the determined key attributes of the original recipe with information provided by a consumer and stored in the second database, generate at least one modified recipe based on the contrast, perform an algorithm that compares the key attributes of the modified recipe to a predetermined criteria, and presents the modified recipe to the consumer along with supplemental information on a condition that the predetermined criteria has been met.

14. The FMPP of claim 13 wherein the criteria indicates at least one of: consumer nutrition restrictions, diet compliance restrictions, food items on hand, shopping list information, position in a food cycle, a food list to be bought prior to need, food item procurement opportunities before need, likes and dislikes, or activities from selected consumers.

15. The FMPP of claim 13 wherein the key attributes are determined based on at least one of: text and images of the presented supplemental information and modified recipe, historical information related to the consumer, historical information related to navigation that brought the consumer to the presented supplemental information and modified recipe, or information available from references the presented supplemental information and modified recipe makes to other sources.

16. The FMPP of claim 13 wherein the algorithm is a like or dislike rating algorithm that is configured to determine potential desirability of modified recipes to a consumer, and recipes to be presented to the consumer are selected based on ratings computed by the like or dislike rating algorithm.

17. The FMPP of claim 13 wherein the contrast performed by the processor determines at least one of: ingredient availability in the dwelling where the recipe is to be prepared, shopping plans, costs to purchase ingredients of the recipe, purchase prices, convenience to obtain, and alternate recipe ingredient options.

18. The FMPP of claim 13 wherein the supplemental information presented is at least one of: selection of stores where at least one necessary ingredient of the recipe can be obtained, brands or stock-keeping units (SKUs) suitable for at least one necessary ingredient of the recipe, or a consumer buying incentive.

19. The FMPP of claim 18 wherein the consumer provided information includes lists indicating which stores the consumer is willing to visit and not willing to visit.

20. The FMPP of claim 19 wherein the lists can be enabled or disabled for selected items or in their entirety at the discretion of the consumer.

21. The FMPP of claim 13 wherein the modified version of the recipe includes at least one brand name of an ingredient of the recipe.

22. The FMPP of claim 13 wherein the modified version of the recipe includes an alternate ingredient that meets a requirement specified by the consumer provided information in place of an ingredient in the original recipe.

23. The FMPP of claim 13 wherein the supplemental information is embedded in the modified recipe.

24. The FMPP of claim 13 where the supplemental information is a trigger for at least one of: advertising, lead generation, affiliate sale, classifieds, featured list, location-based offers, sponsorships, targeted offers, commerce, retailing, marketplace, crowd sourced marketplace, excess capacity markets, vertically integrated commerce, aggregator, flash sales, group buying, digital goods, sales goods, training, commission, commission per order, auction, reverse auction, opaque inventory, barter for services, pre-payment, subscription, brokering, donations, sampling, membership services, insurance, peer-to-peer service, transaction processing, merchant acquiring, intermediary, acquiring processing, bank transfer, bank depository offering, fulfillment, licensing, data, user data, user evaluations, business data, user intelligence, search data, real consumer intent data, benchmarking services, market research, push services, link to an app store, coupons, subscription, online education, crowd sourcing education, delivery, gift recommendation, coupons, loyalty program, alerts, coaching, advertising message budgeting information, audio media rendering, or video media rendering.

25. A non-transitory computer-readable storage medium containing a set of instructions for processing recipe information for presentation to a consumer, the set of instructions comprising:
a first instruction for examining an original recipe stored in a first database of the system to determine key attributes of the original recipe;
a second instruction for contrasting the determined key attributes of the original recipe with consumer provided information stored in a second database;
a third instruction for generating at least one modified recipe based on the contrasting;
a fourth instruction for performing an algorithm that compares the key attributes of the modified recipe to a predetermined criteria; and
a fifth instruction for presenting the modified recipe to the consumer along with supplemental information on a condition that the predetermined criteria has been met.
